(19) United States
(12) Patent Application Publication
(10) Pub. No.: US 2015/0340710 A1
(43) Pub. Date: Nov. 26, 2015

(54) CARBON ELECTRODE AND METHOD THEREFOR

(71) Applicant: United Technologies Corporation, Hartford, CT (US)

(72) Inventors: Weina Li, South Glastonbury, CT (US); Michael L. Perry, Glastonbury, CT (US); Rachid Zaffou, West Hartford, CT (US); Christopher C. Shovlin, Wethersfield, CT (US)

(21) Appl. No.: 14/653,280

(22) PCT Filed: Dec. 23, 2012
(86) PCT No.: PCT/US12/71548

§ 371 Date: Jun. 18, 2015

(51) Int. Cl. H01M 4/96

(52) U.S. Cl. CPC H01M 4/96

(57) ABSTRACT

A method of treating a carbon electrode includes providing a carbon-based electrode that has a surface with chemically different carbon oxides. The surface is treated with a reducing agent to reduce at least a portion of the oxides to a target carbon oxide. In an aspect, a method of treating a carbon electrode includes providing a carbon-based electrode that has a surface with an initial non-zero concentration of a target carbon oxide. The surface is then treated with a reducing agent to increase the initial non-zero concentration of the target carbon oxide.

### BACKGROUND

Flow batteries, also known as redox flow batteries or redox flow cells, are designed to convert electrical energy into chemical energy that can be stored and later released when there is demand. As an example, a flow battery may be used with a renewable energy system, such as a wind-powered system, to store energy that exceeds consumer demand and later release that energy when there is greater demand.

A typical flow battery includes a redox flow cell that has a negative electrode and a positive electrode separated by an electrolyte layer, which may include a separator, such as an ion-exchange membrane. The electrodes can be porous carbon materials, such as graphite felts or graphite papers. A negative liquid electrolyte is delivered to the negative electrode and a positive liquid electrolyte is delivered to the positive electrode to drive electrochemically reversible redox reactions. Upon charging, the electrical energy supplied causes a chemical reduction reaction in one electrolyte and an oxidation reaction in the other electrolyte. The separator prevents the electrolytes from mixing but permits selected ions to pass through to complete the redox reactions. Upon discharge, the chemical energy contained in the liquid electrolytes is released in the reverse reactions and electrical energy can be drawn from the electrodes. Flow batteries are distinguished from other electrochemical devices by, inter alia, the use of externally-supplied, liquid electrolyte solutions that include reactants that participate in reversible electrochemical reactions.

### SUMMARY

Disclosed is a method of treating a carbon electrode. A carbon-based electrode that includes a surface with a plurality of chemically different carbon oxides is provided. The surface is treated with a reducing agent to reduce at least a portion of the oxides to a target carbon oxide.

In another aspect, a method of treating a carbon electrode includes providing a carbon-based electrode that has a surface with an initial non-zero concentration of a target carbon oxide. The surface is then treated with a reducing agent to increase the initial non-zero concentration of the target carbon oxide.

Also disclosed is an electrode that includes a carbon-based material that has an electrochemically active surface with a predominate concentration of a target carbon oxide relative to any other chemically different carbon oxides on the surface.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example electrochemical device.

FIG. 2 illustrates a method of treating a carbon electrode.

### DETAILED DESCRIPTION

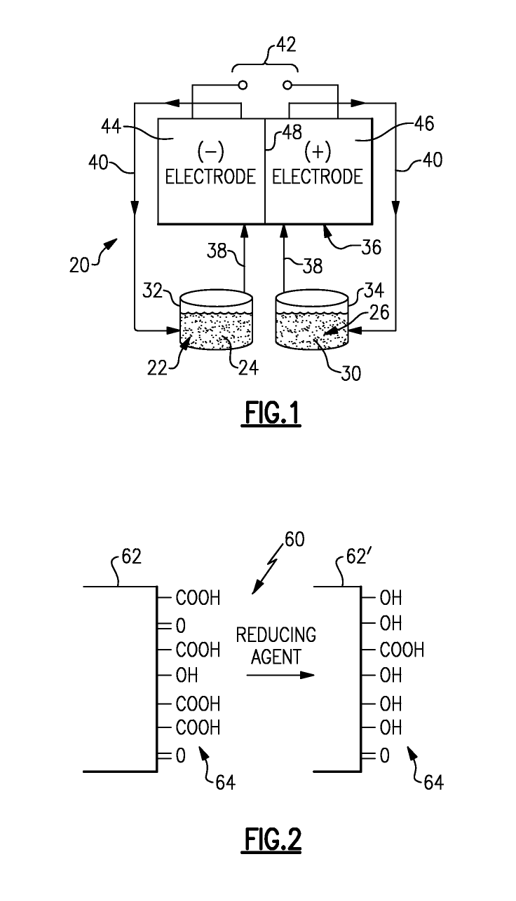

FIG. 1 schematically illustrates selected portions of an example electrochemical device, which in this example is a flow battery 20 for selectively storing and discharging electrical energy. The flow battery 20 can be used to convert electrical energy generated in a renewable energy system to chemical energy that is stored until a later time when there is greater demand at which the flow battery 20 then converts the chemical energy back into electrical energy. The flow battery 20 can supply the electric energy to an electric grid, for example. As will be described, the disclosed flow battery 20 includes features for enhanced stability.

The flow battery 20 includes at least one liquid electrolyte 22 that has an electrochemically active specie 24 that functions in a redox pair with regard to a second reactant 26, which can be another liquid electrolyte with electrochemically active specie 30, or any other electrochemically active specie such as hydrogen or air, for example. For example, the electrochemically active species are based on vanadium, bromine, iron, chromium, zinc, cerium, lead or combinations thereof. In embodiments, the liquid electrolytes 22/26 are aqueous solutions that include one or more of the electrochemically active species 24/30.

The liquid electrolytes 22/26 are contained in respective storage portions 32 and 34, such as tanks. As shown, the storage portions 32 and 34 are substantially equivalent cylindrical storage tanks; however, the storage portions 32/34 can alternatively have other shapes and sizes.

The liquid electrolytes 22/26 are delivered (e.g., pumped) to one or more electrochemical cells 36 of the flow battery 20 through respective feed lines 38 and are returned from the electrochemical cell 36 to the storage portions 32/34 via return lines 40. Thus, the storage portions 32/34 are external of the electrochemical cell 36 and are fluidly connected with the electrochemical cell 36 to circulate the liquid electrolytes 22/26 there through.

In operation, the liquid electrolytes 22/26 are delivered to the electrochemical cell 36 to either convert electrical energy into chemical energy or convert chemical energy into electrical energy that can be discharged. The electrical energy is transmitted to and from the electrochemical cell 36 through an electrical pathway 42 that completes the circuit and allows the completion of the electrochemical redox reactions.

The electrochemical cell 36 includes a first electrode 44 and a second electrode 46. A separator 48, such as an ion-exchange membrane, is arranged between, and in contact with, the electrodes 44/46. In this example, the first electrode 44 is an anode electrode and the second electrode 46 is a cathode electrode. Although not shown, the electrochemical cell 36 can include bipolar plates with flow field channels for delivering the liquid electrolytes 22/26 to the electrodes 44/46. Alternatively, the electrochemical cell 36 can be configured for “flow-through” operation where the liquid electrolytes 22/26 are pumped directly into the electrodes 44/46 without the use of flow field channels.

The electrodes 44/46 are porous carbon-based materials that are electrically conductive and electrochemically active for the desired redox reactions. As an example, one or both of the electrodes 44/46 include fibrous carbon paper or felt materials that have an electrochemically active surface that has a predominant concentration of a target carbon oxide relative to any other chemically different carbon oxides on the surface. For example, carbon oxides are chemical groups that include a carbon atom covalently bonded to at least one oxygen atom and can include carboxyls, carbonyls and carbon hydroxyls.

In one example, the target carbon oxide is one that is chemically and electrochemically stable, and thus the electrodes 44/46 can provide more stable performance in comparison to electrodes that do not have a predominant concentration of the target carbon oxide. In a further example, the target carbon oxide is carbon hydroxyl, which is more chemically and electrochemically stable than carboxylate and carbonyl. In a further example, the predominant concentration of carbon hydroxyl species represents more than 50% of the surface carbon oxide species.

FIG. 2 schematically depicts a method 60 of treating a carbon electrode 62 to produce either of the electrodes 44/46, which is indicated at 62′. The carbon electrode 62 is a carbon-based material, such as graphite, and includes a surface 64 that has a plurality of chemically different carbon oxides. The carbon oxides can be pre-existing on the surface 64 from a prior oxidation treatment, for example. Alternatively, the method 60 can include oxidizing the surface 64 in an oxidation treatment to initially generate the carbon oxides or increase the concentration of carbon oxides that are already present. For example, the oxidation treatment can include treating the carbon electrode 62 in acid, heat treating the carbon electrode 62 in an oxygen-containing environment or a combination thereof.

In this example, the carbon oxides include a mixture of carboxyls, hydroxyls and carbonyls. The surface 64 is then treated with a reducing agent to reduce at least a portion of the carbon oxides to a target carbon oxide, as shown on the right hand side of the drawing. The carbon-based electrode 62 includes an initial non-zero concentration of a target carbon oxide. Upon treatment with the reducing agent to reduce at least a portion of the carbon oxides to the target carbon oxide, the treated carbon-based electrode 62′ has a greater concentration of the target carbon oxide, which in this example is hydroxyl. In other examples, the target carbon oxide can be a chemically different carbon oxide than hydroxyl.

Carbon-based electrodes, such as graphite fiber-containing electrodes, can be used for the electrodes 44/46 of the flow battery 20. However, especially at the negative electrode 44, the electrochemical performance can degrade over time due to instability of the surface oxides that participate in the catalytic and electrochemical activity. As an example, graphite electrodes can be activated by treatment in an oxidizer, such as air, to produce the chemically different carbon oxides on the surface 64 of the carbon-based electrode 62. However, at least some of these carbon oxides are relatively unstable in comparison to other types of oxides. For instance, carboxyl and carbonyl groups are relatively unstable in comparison to hydroxyl groups. Thus, the method 60 utilizes the reducing agent to reduce the less stable oxides into more stable oxides and thus enhance the stability of the treated carbon-based electrode 62′.

In one example, the reducing agent is included in a non-aqueous solution and includes an alkali metal. The alkali metal is lithium, sodium or combinations thereof. In a further example, the reducing agent is NaBH₄, LiAlH₄, LiBH₃, although other hydrides could alternatively be used. In one further example, the solution is a 1-3 molar solution. Alternatively, other reducing agents, including organic reducing agents, such as diborane (B₂H₆) or metal-organic agents, can be used. At least for the alkali reducing agents, the treatment can be conducted at temperatures around room temperature, such no greater than 30° C. However, higher temperatures can be used to accelerate the treatment or to permit the use of reducing agents that have relatively lower reaction rates.

In one example, the carbon-based electrode 62 is exposed to the reducing agent solution, such as by spraying or dipping the carbon-based electrode 62 in the reducing agent solution, to chemically convert at least a portion of the carbon oxides on the surface 64 to the target carbon oxide. The carbon-based electrode 62 can be soaked or exposed to the reducing agent solution for a predetermined about of time, such as up to several hours. However, it is to be understood that the time can vary depending upon the strength of the reducing agent and the size of the carbon-based electrode 62. Upon removal from the reducing agent solution, the treated carbon-based electrode 62′ can be washed in water and/or acid to remove any residual reducing agent and byproducts of the reducing agent, such as NaCl or LiCl if HCl is used for the washing. The treatment is thus a relatively mild, wet-chemistry treatment.

In one example, the carbon-based electrode 62 initially has a non-zero concentration of the target carbon oxide. After the treatment according to the method 60, the treated carbon-based electrode 62′ has a predominate concentration of the target carbon oxide, which in a further example are carbon hydroxyl species, which can represent more than 50% of the surface carbon oxide species.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A method of treating a carbon electrode, the method comprising:
providing a carbon-based electrode including a surface that has a plurality of chemically different carbon oxides; and
treating the surface with a reducing agent to reduce at least a portion of the plurality of chemically different carbon oxides to a target carbon oxide.

2. The method as recited in claim 1, wherein the target carbon oxide is carbon hydroxyl.

3. The method as recited in claim 1, wherein the plurality of chemically different carbon oxides includes carboxyls.

4. The method as recited in claim 1, wherein the reducing agent is in a non-aqueous solution.

5. The method as recited in claim 1, wherein the reducing agent includes an alkali metal.

6. The method as recited in claim 5, wherein the alkali metal is selected from the group consisting of lithium, sodium and combinations thereof.

7. The method as recited in claim 1, wherein the reducing agent is included in 1-3 molar non-aqueous solution.

8. The method as recited in claim 1, wherein, after the treating of the surface, the surface has a concentration of the target carbon oxide of more than 50% of the total carbon oxide species on the surface of the electrode.

9. The method as recited in claim 1, wherein the reducing agent is an organic reducing agent selected from a group consisting of diborane (B₂H₆), metal-organic agents and combinations thereof.

10. The method as recited in claim 1, wherein the reducing agent is a hydride.

11. The method as recited in claim 1, wherein the plurality of chemically different carbon oxides include carbonyls and carboxylates.

12. The method as recited in claim 1, wherein the reducing agent is selected from the group consisting of NaBH₄, LiAlH₄ LiBH₃ and combinations thereof.

13. The method as recited in claim 1, further comprising oxidizing the surface in an oxidation treatment to generate at least a portion of the plurality of chemically different carbon oxides.

14. A method of treating a carbon electrode, the method comprising:
providing a carbon-based electrode including a surface that has an initial non-zero concentration of a target carbon oxide; and
treating the surface with a reducing agent to increase the initial non-zero concentration of the target carbon oxide.

15. The method as recited in claim 14, wherein the target carbon oxide is carbon hydroxyl.

16. The method as recited in claim 14, including treating the surface at a temperature of no greater than 30° C.

17. The method as recited in claim 14, including treating the surface with the reducing agent to provide a concentration of the target carbon oxide on the surface of more than 50%.

18. The method as recited in claim 14, including treating the surface with the reducing agent to provide a predominate amount of the target carbon oxide relative to any other chemically different carbon oxides on the surface.

19. An electrode comprising:
a carbon-based material including an electrochemically active surface that has a predominant concentration of a target carbon oxide relative to any other chemically different carbon oxides on the surface.

20. The electrode as recited in claim 19, wherein the predominate concentration is of the target carbon oxide is more than 50% of the total carbon oxide species, and the target carbon oxide is carbon hydroxyl.

21. The electrode as recited in claim 19, wherein the carbon-based material includes carbon fibers.
